(19) United States
(12) Patent Application Publication
(10) Pub. No.: US 2017/0372396 A1
(43) Pub. Date: Dec. 28, 2017

(54) EVENT BASED DEFERRED SEARCH METHOD AND SYSTEM

(71) Applicant: Maria Francisca JONES, Middlesex (GB)

(72) Inventors: Maria Francisca JONES, Middlesex (GB); Alexander JONES, Middlesex (GB)

(21) Appl. No.: 15/642,239

(22) Filed: Jul. 5, 2017

Related U.S. Application Data
(63) Continuation-in-part of application No. 15/395,321, filed on Dec. 30, 2016.

(30) Foreign Application Priority Data
Dec. 31, 2015 (GB) 1523166.5

(51) Int. Cl. G06Q 30/06; G06F 17/30; G06Q 10/10

(52) U.S. Cl. CPC G06Q 30/0623; G06Q 30/0635; G06Q 10/1093; G06F 17/30867; G06F 17/30967; G06F 17/30991

(57) ABSTRACT

A method and system for performing deferred searching comprising receiving an event input identifying event data for an event on an event date in the future from a user at a user interface, receiving a query input from the user at the user interface, processing the query input using the event data to generate a query using a processor, transmitting the query in dependence upon the event data, and receiving search results responsive to the transmitted query.

### RELATED APPLICATIONS

This application is a continuation in part of U.S. patent application Ser. No. 15/395,321 filed on Dec. 30, 2016 and entitled “DIRECT INTEGRATION SYSTEM”, which claims priority to Great Britain patent application GB1523166.5 filed Dec. 31, 2015, the contents of which are hereby incorporated by reference in their entirety.

### FIELD OF THE INVENTION

The present disclosure relates to methods and systems for deferred searching, and more specifically a method and system for deferred searching based on a future event.

### BACKGROUND INFORMATION

In people's busy lives, there is often a need for a user to perform a search in response to or based on a future event, such as a personal event such as a birthday, or a business event such as a meeting or appointment. The search may be required to provide information for the event, or to perform a specific action on search result data for the event e.g. to provide business search result data for a business meeting or to order or purchase an item for a birthday.

Such searches usually access online resources such as web sites. The data providing the search results of such online resources can and often are updated frequently. Therefore if a search is performed in advance of the event it may not be accurate or it may miss data that later becomes available. In addition, it may be necessary to perform the search no later than a predetermined period before the event, if the search requires something to be delivered responsive to the results of the search i.e. a delivery lead-time for search result items. However, it may not be possible for a user to be able to undertake the search at the optimum time and a user may have no knowledge or understanding of when such an optimum time might be.

### SUMMARY OF THE INVENTION

One aspect provides a method of deferred searching, the method comprising receiving an event selection identifying event data for an event on an event date in the future from a user; receiving a query input selection from the user; processing the query input selection using the event data to generate a query; transmitting the query in dependence upon the event data; and receiving search results responsive to the transmitted query.

Another aspect of the invention provides a system for deferred searching comprising at least one processor, and a memory storing instructions, which instructions being executable by the at least one processor to receive an event selection identifying event data for an event on an event date in the future from a user; receive a query input selection from the user; process the query input selection using the event data to generate a query; transmit the query in dependence upon the event data; and receive search results responsive to the transmitted query.

Another aspect of the invention provides a carrier medium or a storage medium carrying code executable by a processor to carry out the deferred search method.

### BRIEF DESCRIPTION OF THE DRAWINGS

FIG. 1A is a schematic diagram illustrating a generalized system according to one embodiment;

FIG. 1B is a schematic diagram illustrating a generalized system according to another embodiment;

FIG. 2 is a flow diagram of a deferred search method using the system of FIG. 1 according to one embodiment;

FIG. 3 is a schematic diagram illustrating a system according to one embodiment;

FIGS. 4A to 4C are a flow diagram of a deferred search method using the system of FIG. 2 according to one embodiment;

FIGS. 5A to 5C are user interfaces generated during the method of FIGS. 2A to 2C according to one embodiment; and

FIG. 6 is a schematic diagram of a basic computing device for use in one embodiment.

### DETAILED DESCRIPTION

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

In the following embodiments, like components are labelled with like reference numerals.

In the following embodiments, data is described as being stored in at least one database. The term database is intended to encompass any data structure (and/or combinations of multiple data structures) for storing and/or organizing data, including, but not limited to, relational databases (e.g., Oracle databases, mySQL databases, etc.), non-relational databases (e.g., NoSQL databases, etc.), in-memory databases, spreadsheets, as comma separated values (CSV) files, eXtendible markup language (XML) files, TeXT (TXT) files, flat files, spreadsheet files, and/or any other widely used or proprietary format for data storage. Databases are typically stored in one or more data stores. Accordingly, each database referred to herein (e.g., in the description herein and/or the figures of the present application) is to be understood as being stored in one or more data stores. A “file system” may control how data is stored and/or retrieved (for example, a disk file system like FAT, NTFS, optical discs, etc., a flash file system, a tape file system, a database file system, a transactional file system, a network file system, etc.). For simplicity, the disclosure is described herein with respect to databases. However, the systems and techniques disclosed herein may be implemented with file systems or a combination of databases and file systems.

In the following embodiments, the term data store is intended to encompass any computer readable storage medium and/or device (or collection of data storage mediums and/or devices). Examples of data stores include, but are not limited to, optical disks (e.g., CD-ROM, DVD-ROM, etc.), magnetic disks (e.g., hard disks, floppy disks, etc.), memory circuits (e.g., solid state drives, random-access memory (RAM), etc.), and/or the like. Another example of a data store is a hosted storage environment that includes a collection of physical data storage devices that may be remotely accessible and may be rapidly provisioned as needed (commonly referred to as “cloud” storage).

The functions or algorithms described herein are implemented in hardware, software or a combination of software and hardware in one embodiment. The software comprises computer executable instructions stored on computer readable carrier media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

A generalized embodiment provides a deferred method and system for receiving an event selection identifying event data for an event on an event date in the future from a user, receiving a query input selection from the user, processing the query input selection using the event data to generate a query, transmitting the query in dependence upon the event data, and receiving search results responsive to the transmitted query.

The query can be transmitted to a data store locally or over a network, so that the query can be satisfied with search results from data stored locally or data stored remotely over a network.

The user can be an individual or a unit or entity such as a business. The event can thus be associated with the user, unit, entity or business.

Thus embodiments of the invention enable a user to select an event in the future that will be used to trigger or initiate a query. The event can be an event on a specific date and possibly even at a specific time. The event can also be an event that is associated with a period of time or range, such as a day, a few days, a week or a month. In one embodiment, events can be associated directly with specific users/people, such as a birthday or anniversary. The event can be associated with just one person, such as a birthday, or it can be associated with multiple people, such as a wedding anniversary or a team anniversary or holiday. Events can also be associated with specific users/people indirectly, such as Christmas, Halloween, Easter etc. In such cases, while the event itself is not inherently associated with individuals, a user can assign individuals to the event in relation to the search query to be performed, e.g. the event can be Christmas, the person David can be associated, and the search to be performed relates to a search for a present for David. In this embodiment, the user is required to input an individual, David, to be associated with the event. The event can be an event in a diary or calendar of the user or a shared diary or calendar used by the user. The event could be a meeting or a telephone call that needs to be made on the event date and time and the query can relate to data needed for that meeting or call, such as documents or research data.

Thus in one embodiment, the event data has data identifying one or more users associated with the user, or the method includes receiving data identifying one or more users associated with the user, and the processing of the query input includes using the data identifying one or more associated users to generate the query. The processing of the query input using the data identifying one or more associated users to generate the query can include using the data identifying one or more associated users to determine data related to the one or more associated user, and using the data related to the one or more associated users to generate the query.

Data for users can comprise personal data for the user and personal data for associated users, such as friends, family and colleagues. The personal data can comprise private data not to be shared with other users, history data identifying previous actions by a user, such as web browsing activity and transaction history, and user preference data which can comprise data representing manually input user preferences and automatically determined user preferences. This facilitates a personalized search.

In embodiments, the event can relate to a product to be delivered to the user. The product can be a physical product, an intangible product or a service. The search can therefore be performed according to the query to search for a product related to the event. A physical product could be a toy to be delivered to someone on his or her birthday, when the event is a birthday. Equally, the product in such a case could be an intangible or virtual product, such as a downloaded product, e.g. music, video, a voucher, a computer program or app, etc. If the product is a service, the service could relate directly to the event, in that the event is the delivery of the service. For example, the event could be a doctor, hospital or dentist appointment that the user wants to attend on the event date. The query can hence be a query of the booking system for the making of the appointment and the search results are potential appointments available for user selection. Similarly, the service could be the attendance of a tradesman such as a plumber or electrician required on the event date and the search query is, for example, sent to an automated booking system for the tradesman, so that the search results are one or more offered appointments.

In one embodiment, the method uses the search results to perform one or more electronic transactions. The transaction can include the ordering of a product as a physical or intangible product or a service. The process can be manual in which the search results are output for display and a user selection of one or more search results is received, wherein the or each electronic transaction is performed using the user selected one or more search results. In another embodiment, the process is automatic in which a selection for automatic purchase from the user in association with the query input is received, and the or each electronic transaction is performed automatically using the search results.

The search can be highly automated, in that the user can simply select for an automated search, wherein the query is selected using the event data and any data on associated individuals i.e. individual people or individual units, such as a business, charity social club etc. For example, the user may select for an automated search for David's birthday. The query can be automatically determined using data on the event and David, such as David's preferences for birthday presents, or his purchase history.

The search can also be manual, wherein the query input comprises a user input text string as a search query, and the user input text string is processed using the event data to generate a query.

It may not be appropriate to defer a search to be carried out on the event date, since this may be too late to meet the user's requirements related to the event. For example, if the user is ordering David's birthday present, it is too late generally to order it on the actual birthday. Similarly if the user is ordering a service to be delivered or the booking of an appointment for the event date and time, then it is necessary to perform the search in advance of the event date and time. Thus, an action date can be determined as part of the event data. The action date is prior to the event date, and the query is transmitted on the action date. The action date can specify a date or a date and time that the search query is to be transmitted. The action date can be tied to the event data by related data such that if the event date is moved, the action date moves relatively with it e.g. to stay a fixed or determined period before it e.g. 1 week.

The action date can be determined manually by a user entering an input or it can be determined automatically based on information related to the search results. In other words, the action date can be determined based on the type of results that will be returned in the search. This can be based on some general concept of the type of search results being returned or based specifically on the search results. In order to provide the latter, the query is transmitted and initial search results received responsive to the query before the transmitting of the query in dependence upon the event data, and the action date is determined using the initial search results. Thus, a pre-search can be carried out and the search results analysed to determine an appropriate action date and optionally time to perform the actual search. In one example, the analysis of the search results could determine product availability and delivery time for products identified in the search results. Such information can be made available from the suppliers of the products.

In another example, the determination of the action date can be based on the type of event. Also, data on the results of the search can be used with the event type. For example, where the event is an appointment, meeting or a service, it may be known that for this type of event there is a known period prior to the event that a query should be submitted to return results in time for the event. For example, it may be known that to book an appointment with the doctor, an appointment must be made 7 days in advance.

One aspect provides a method of deferred automated ordering of products including services in which a user identifies an event and initiates an order or purchase request whereby the system uses the event data to search for one or more suitable products and automatically places an order for the product for the event. The order process can include the use of an action date to trigger the search and ordering process in advance of the event date to ensure that the or each product can be made available by the event date. As part of the event data or as a separate input, one or more individuals can be identified as associated with the event and data on the one or more individuals can be used in the determination of a search query used for the searching for products including services for ordering.

The user interface can, in one embodiment, be provided as a conventional web site having a displayed output and a pointer device and keyboard input by a user. In alternative embodiments, the interfaces can be provided by any form of output e.g. visual, or audible, and any form of input such as keyboard, touch screen, pointer device (such as a mouse, trackball, trackpad, or pen device), audio recognition hardware and/or software to recognize a sounds or speech from a user, gesture recognition input hardware and/or software, etc.

In one embodiment, the user interface can be provided using the method disclosed in co-pending U.S. patent application Ser. No. 15/395,343, filed 30 Dec. 2016 and entitled “USER INTERFACE METHOD AND APPARATUS”, the content of which is hereby incorporated in its entirety. The user interface of U.S. Ser. No. 15/395,343 can provide a means by which the user interacts with the system for inputs and selections.

In one embodiment, the method and system can be used with the electronic transaction method and system disclosed in copending U.S. patent application Ser. No. 15/395,487, filed 30 Dec. 2016 and entitled “AN ELECTRONIC TRANSACTION METHOD AND APPARATUS”, the content of which is hereby incorporated in its entirety. The transaction method and system of U.S. Ser. No. 15/395,487 can be used as the transaction process using the search results obtained using the process of embodiments of the invention.

In one embodiment, the method and system can be used with the method and apparatus disclosed in copending U.S. patent application Ser. No. ______, filed on the same date as this application and entitled “METHOD AND APPARATUS TO TRANSFER DATA FROM A FIRST COMPUTER STATE TO A DIFFERENT COMPUTER STATE”, the content of which is hereby incorporated by reference in its entirety.

In one embodiment, the method and system can be used with the method and apparatus disclosed in copending U.S. patent application Ser. No. ______, filed on the same date as this application and entitled “VIRTUAL OFFICE”, the content of which is hereby incorporated by reference in its entirety.

In one embodiment, the method and system can be used with the method and apparatus disclosed in copending U.S. patent application Ser. No. ______, filed on the same date as this application and entitled “VIRTUAL MEETING PARTICIPANT RESPONSE INDICATION METHOD AND SYSTEM”, the content of which is hereby incorporated by reference in its entirety.

Specific embodiments will now be described with reference to the drawings.

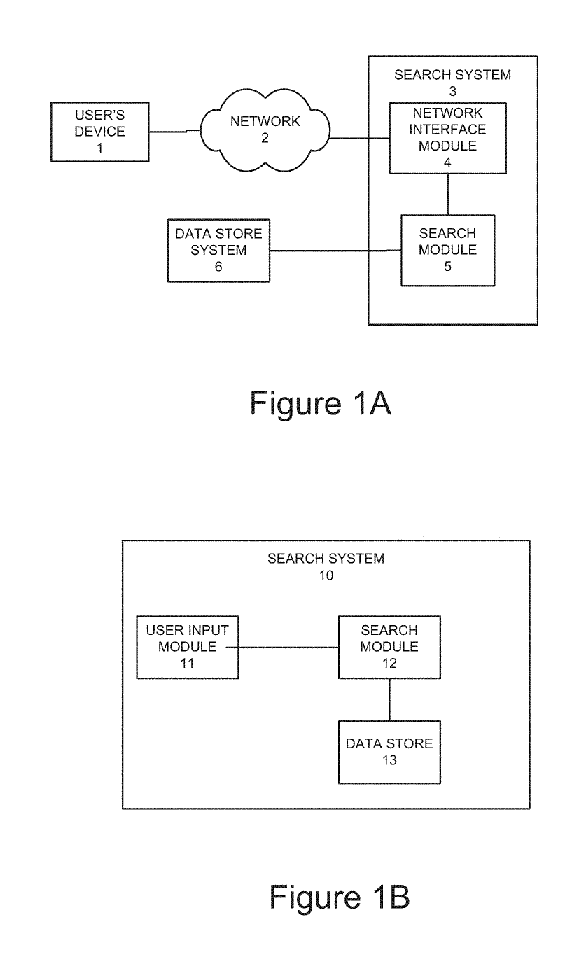

FIG. 1A illustrates a generalized system according to one embodiment.

FIG. 1A illustrates a user's device 1, for use by a user. Any number of user's devices may be used. The user's device 1 can comprise any type of computing or processing machine, such as a personal computer, a laptop, a tablet computer, a personal organizer, a mobile device, smart phone, a mobile telephone, a video player, a television, an audio player, line a multimedia device, personal digital assistant, etc.

The user's device 1 is connected to a communications network 2, such as the internet. A search system 3 comprising one or more computers is connected to the network 2 and comprises a network interface module 4 for interfacing to the network 2, a search module 5 connected to the network interface module 4 for receiving search queries from the user's device and performing searches in a connected data system store 6. The data store system 6 can be connected to the search system 3 by a dedicated connection or through the network 2.

A generalized system according to another embodiment is illustrated in FIG. 1B.

A deferred search system 10 includes a user interface 11 to allow a user to input a query input and an event input and to be able to view search results. A search module 12 is connected to the user interface module 11 to process the query input using the event input to generate a query which is to be transmitted internally to a connected data store 13 so that search results can be received and output to the user interface module 11.

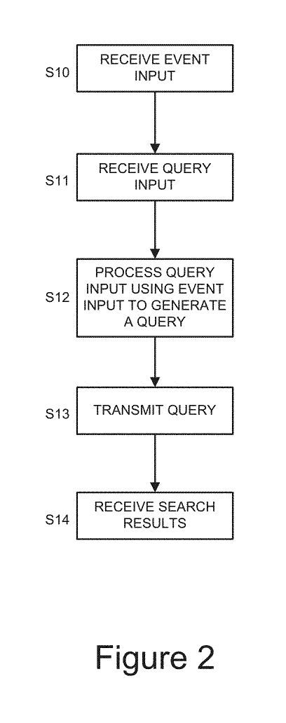

FIG. 2 is a flow diagram of a process for performing deferred searches using the system of FIG. 1A or 1B according to one embodiment.

In step S10 the search system 3 receives an event input from the user's device 1. The event input can simply comprise an identifier for event data stored in the data store 6 at the search system 3 or it can include event data. In step S11 the search system 3 receives a query input from the user's device 1. The query input can include query text as a text string or an automated search determination input where the search system is to make an automated search based on data stored for the event e.g. the event is Easter, so search for Easter themed items to purchase, or the event is David's birthday so search for products that David is interested in based on data stored for David in the data store 6.

In step S12 the query input is processed using the event input to generate a query and in step S13 the query is transmitted to the data store system 6 for the retrieval of search items. In step S14, the search system 3 receives the search results. The search results can be output for display on the user's device 1 for the reception of a manual selection of a search result item or a search result item can be automatically selected based on a search result ranking process e.g. the closest matching search result item to the query. The result of the manual or automatic selection of search result item is ordering of a product, including the booking of a service or appointment or meeting.

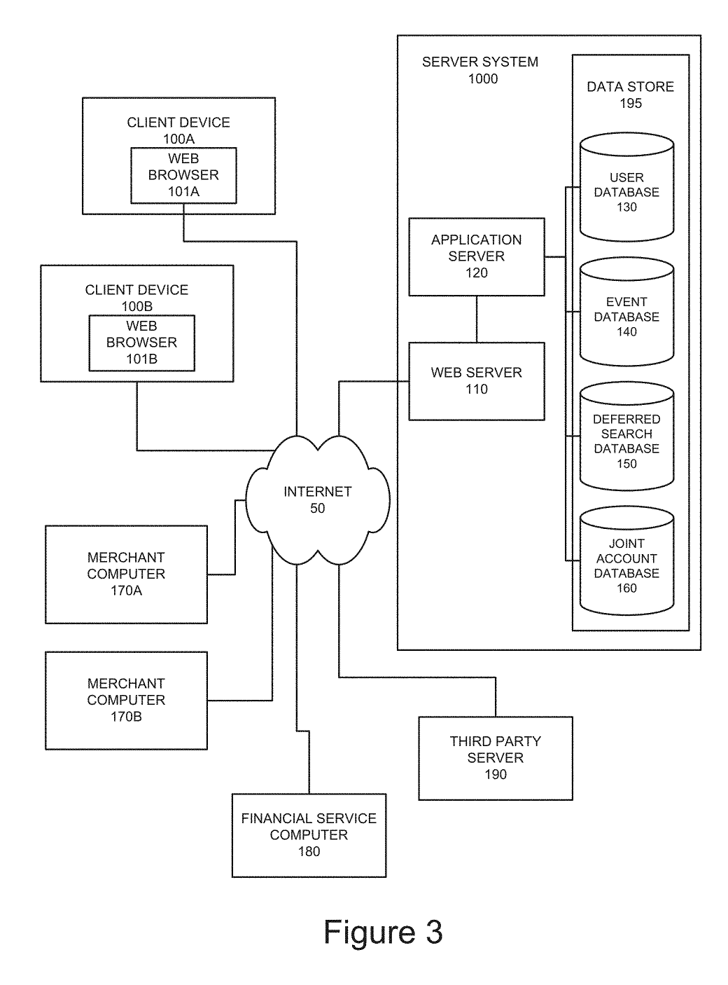

FIG. 3 illustrates a system according to one embodiment.

FIG. 3 illustrates two client devices 100A and 100B, each for use by a user. Any number of client devices may be used. The client devices 100A and 100B can comprise any type of computing or processing machine, such as a personal computer, a laptop, a tablet computer, a personal organizer, a mobile device, smart phone, a mobile telephone, a video player, a television, an audio player, a multimedia device, personal digital assistant, etc. In this embodiment each client device executes a web browser 101A and 101B to enable it to interact with hosted web pages at a server system 1000. In an alternative embodiment, the web browser 101A and 101B can be replaced by an application running on the client devices 100A and 100B.

The client devices 100A and 100B are connected to a network, which is this example is the internet 50. The network can comprise any suitable communications network for networking computer devices.

The server system 1000 comprises any number of server computers connected to the internet 50. The server system 1000 operates to provide the service according to embodiments of the invention. The server system 1000 comprises a web server 110 to host web pages to be accessed and rendered by the browsers 101A and 101B. An application server 120 is connected to the web server 110 to provide dynamic data for the web server 110. The application server 120 is connected to a data store 195. The data store 195 stores data in a number of different databases, namely a user database 130, an event database 140, a deferred search database 150 and a joint account database 160.

In this embodiment, the search performed as a result of in input query is a search for a vendible product from one or more merchants or a merchant intermediary (termed hereinafter ‘domains’), such as eBay® or Amazon®. Hence, in this embodiment two merchant computers 170A and 170B are connected to the internet 50 to be accessible to the server system 1000. A financial service computer 180 is also provided connected to the internet 50 to provide the server system with access to financial services. Also, a third party server 190 is illustrated connected to the internet 50 and operated by a trusted third party to allow the trusted third party to access data for users in the data store 195 of the server system 1000.

User Data

The user data stored in the user database 130 can comprise personal data related to the user and the associated users or individuals, such as friends, family and colleagues. Each user of the search system has a user account and the following data is stored for the user in the user account:
User ID—unique identifier for the user.
Username and password for secure login, PIN etc.
User identifying information—name, address, telephone numbers, data of birth, male/female, age/age range, etc.
Preference data—sizes, styles, colours, hobbies, preferences, brands, products, quantity of order for business bulk ordering etc. This stores user input and any automatically determined preferences. This data can also contain a wish list for the user.
Payment information—identification of credit card or bank payment details and any other information needed for the payment for products/services. Also data on any vouchers for use in purchases can be stored as part of this data.
Joint account ID—The identifier identifying any joint accounts that the user shares with other users for joint payment for products.
Budget—e.g. Information to limit expenditure on transactions, such as single item limit or aggregate limits for a period such as a week or month.
Delivery information—delivery preferences for products including delivery method preferences, delivery time preferences and delivery address(es) etc.
User History—information gathered recording user activity such as user browsing history and user transaction history.
Associated user ID—Identifiers for users associated with the user, such as friends, family or colleagues, that the user wishes to allow access to their data.
Calendar event IDs—identifiers for events in the calendar or diary of the user.
Deferred search IDs—identifiers for search data related to events.
Secure User IDs—identifiers of secure users allowed to access the user data.

Associated User ID Data

The associated user data is stored in the user database 130 and comprises personal data related to the associated user. For each associated user the following data is stored:
Associated user ID—a unique identifier to the associated user.
Username and password for secure login for those associated users that are also users. Not all associated users need to be users of the system. Some associated users are just references by users to enable purchases to be made by the user and to allow sharing of the associated user data with other users of the system.
User identifying information—name address, telephone numbers, data of birth, male/female, age/age range, etc.
Preference data—for example sizes, styles, colours, hobbies, preferences, brands, products, quantities, etc. This stores system user input and any automatically determined preferences for the associated user. This data can also contain a wish list for the associated user.
Calendar event IDs—identifiers for events in the calendar or diary of the associated user.
Associated User History—information gathered recording transaction history for the associated user i.e. products purchased before by users for the associated user.
Joint account ID—The identifier identifying any joint accounts that the associated user shares with other users or associated for joint payment for products. This allows an associated user to make payments towards products.

### Secure Third Party Data

The secure third party data is stored in the user database 130 and comprises data related to the secure third party. For each secure third party the following data is stored:
Secure user User ID—unique identifier for the user.
Username and password for secure login.
Access level—level of access to user data. For example, a bank may have one level of access while a pharmacy would have a different level of access.

### Event Data

The event data is stored in the event database 140 and comprises data related to the event. For each event the following data is stored:
Event ID—a unique identifier for the event.
Event name—e.g. Christmas, David's birthday, business stock up day etc.
Event date—the date can be specific such as a date and time or just a date range e.g. dates over 1 week or 1 month.
Event information—The user can add information describing the event or information can be added by default on certain events. The information can also include location information for the event and map data to enable a map to be displayed to a user to show the location of the event. For example, the event could be a doctor's appointment and the location could be the address of the doctor, or the event could be a birthday that will include a birthday party and the location could be the address of the party.
Related products—any product identification data for products including services associated with the event, e.g. Easter themes items or activities for the event name Easter.
Associated user IDs—any user or associated user IDs associated with the event e.g. David for his birthday. This data is present when the data stores one or more users in association with an event. Not all events have associated user IDs. A user can select to input an associated user name for an event e.g. for Christmas, Jane can be input then the user wishes to buy Jane a gift for Christmas.
Action date—some events are of a type that has their own defined action date to cause the initiation of the search. This may be due to the event relating to only a certain type of search data e.g. the booking of a doctor's appointment.

### Joint Account ID Data

The joint account data is stored in the joint account database 160 and comprises data related to joint accounts accessed by users and associated users. For each joint account the following data is stored:
Joint account ID—a unique identifier for the joint account.
Account details—sole funded—linked to admin under bank account.
   Virtually funded—account can be contributed to by associated users and guests.
Admin user ID—user ID of user who is administrator for the joint account.

### Deferred Search Data

The deferred search data is stored in the deferred search database 150 and comprises data related to the deferred search. For each deferred search the following data is stored:
Deferred search ID—a unique identifier for the deferred search.
Event ID—the event ID of the event to which the deferred search relates.
Search automatic—Set if the search is selected to be an automated search with no user input search string. In such cases the search uses information on the event and user preference data to determine an appropriate search query.
Search string—any input search text by the user.
Domain for the search—the domain e.g. the merchant or merchant aggregator (eBay® or Amazon®) to which the search query is directed.
Action date—the date the search is to be triggered (not required if the event data has a default action date).
Pre-search results—if a pre-search was performed, the results of the pre-search are stored for use in the deferred search.

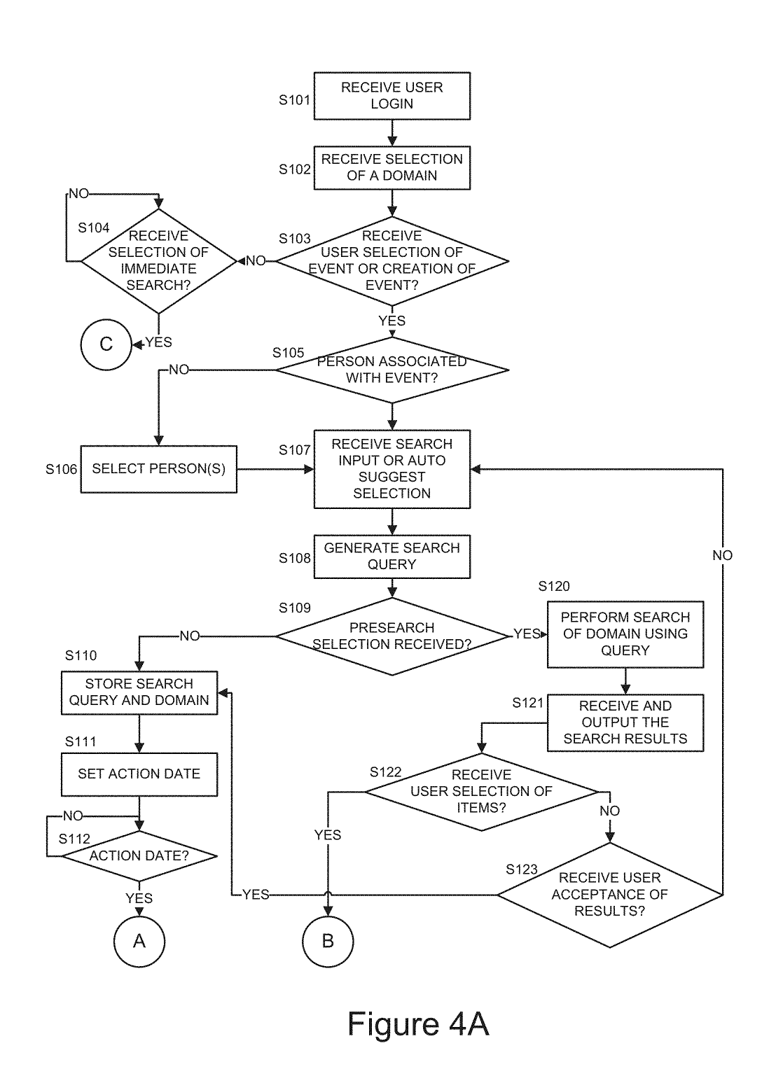

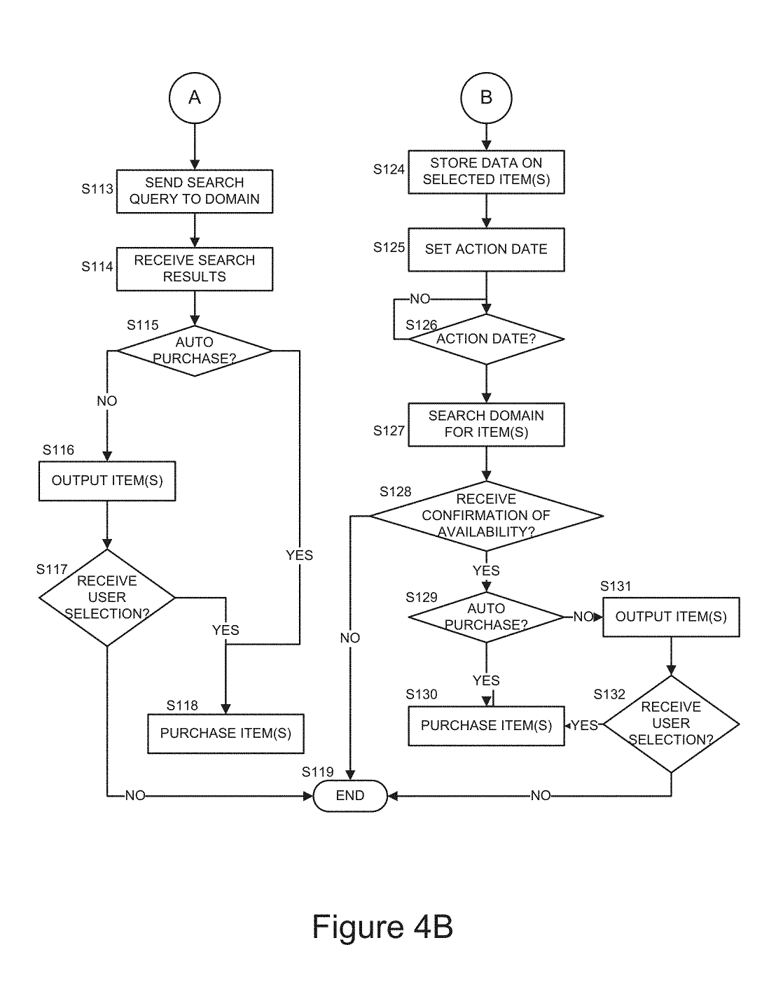

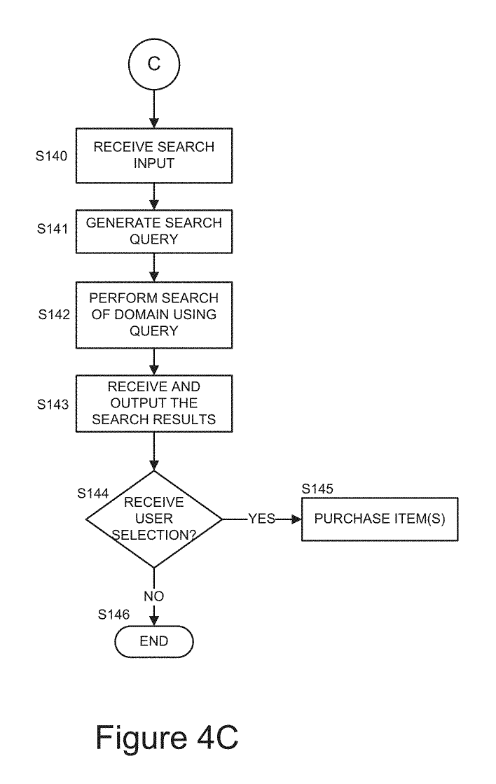

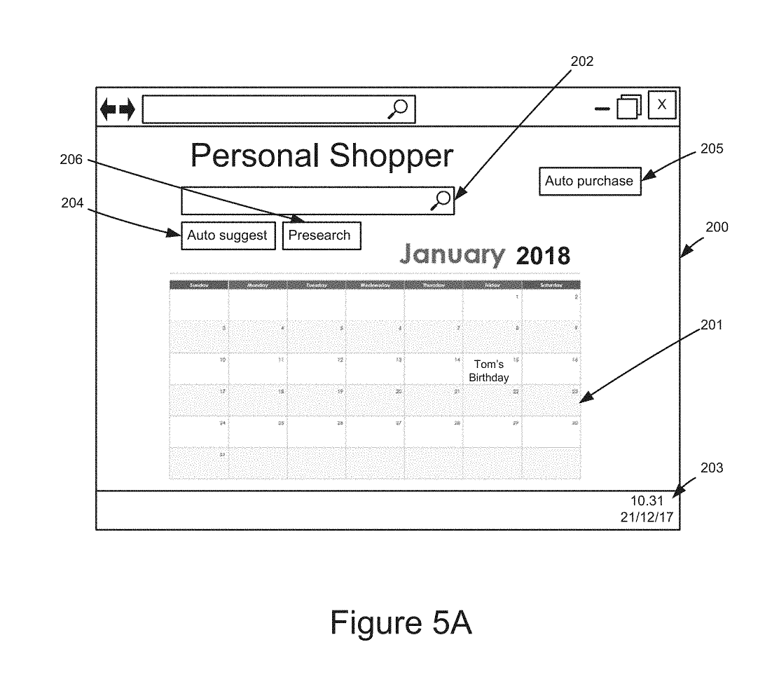

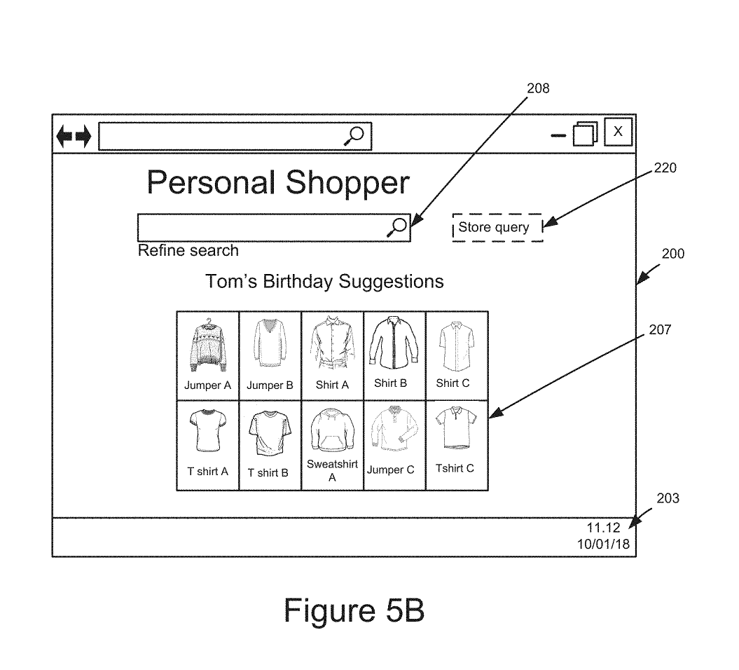

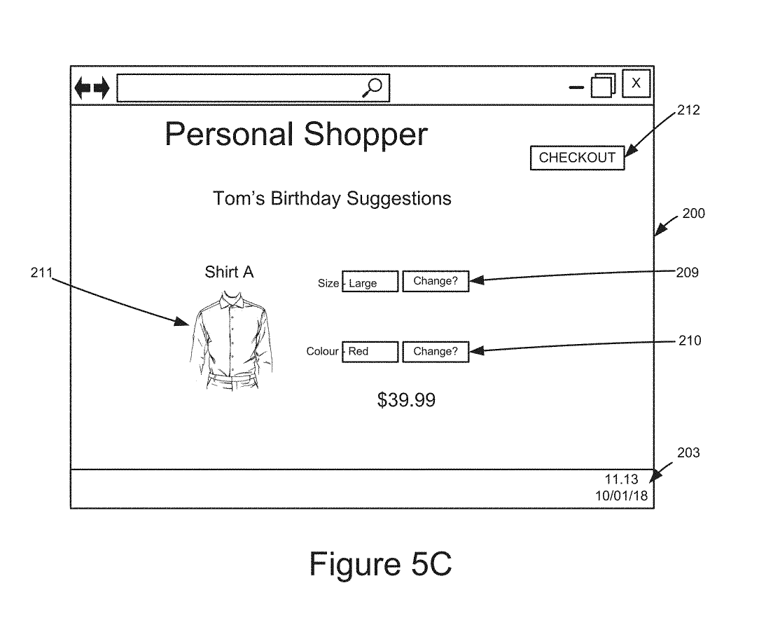

The operation of the system of FIG. 3 for the process according to one embodiment will now be described with reference to the flow diagram of FIGS. 4A to 4C and the schematic diagrams of user interfaces of FIGS. 5A to 5C generated through a process of the flow diagram of FIGS. 4A to 4C.

In step S101 in FIG. 4A the system 1000 receives a user login and assuming the user is successful in the login the system receives a user selection of a domain in step S102. A domain is a selection by a user of a domain or environment in which the search is to be focused or targeted. In a transaction system for ordering and purchasing products, the domain comprises a merchant or a merchant aggregator such as eBay® or Amazon®. In an appointment booking embodiment, the domain would be chosen to be the booking system e.g. the doctors.

In step S103 the system determines whether a user event selection has been received from the user. If not in step S104 the process waits for receipt of a selection from a user to carry out an immediate search. Then in step S140 (in FIG. 4C) the system receives a search input from the user and generates a search query in step S141. The search query is then transmitted to the domain to perform the search in step S142 and in step S143 the search results are received and output for display at the client device 100A or 100B. In step S144 the system waits for the user to make a selection of an item in the search results. If no selection is made the process terminates in step S146. If the user makes a selection, in step S145 the process proceeds to place an order to purchase the item.

If in step S103 in FIG. 4A the user selects an event or creates an event, in step S105 the system determines whether there is any person or persons associated with the event by whether there is any user ID(s) in the event data. If there is not, in step S106, the system allows a user to input data to select one or more users or associated users. Then in step S107, a search input or an auto suggest selection is received from the user and in step S108 a search query is generated. The search query uses event data and user data or associated user data together with either the auto selection or the user input search selection to generate a query. For example, if the event is Birthday and the user identified is David, the user data for David will be used to identify parameters to add into a search query to search for a suitable gift for David. For example, David's hobby might be fishing. Therefore, the search query could be generated to include ‘fishing gift’. This becomes a recommendation search for a gift for David's birthday.

In step S109 the system determines whether a user selection to perform a pre-search has been received. The purpose of a pre-search is to allow a user to see the results of the search to see whether the search string that they input or whether the selection of the auto option generates results that they feel are suitable so that they can modify their search input if they feel the search results are not what they want.

If in step S109 no pre-search is selected, in step S110 the search query is stored with the domain in the deferred search database 150. In step S111 an action date is set. This can be based on a predefined period before the event date or on a user input selection of when they would like the search to be performed to ensure that any action that needs to be taken, such as ordering, is done in time for the event.

The process then waits for the action date to arrive in step S112. On the action date in step S113 in FIG. 4B the search query is sent to the search domain and in step S114 the search results are received. In step S115 the system then determines whether the user has selected for there to be an automatic purchase based on the search results. If so, in step S118 a process is carried out to place an order or purchase a product based on the search results. The product automatically selected for purchase can be identified as the best matching result to the search query in the search results.

If in step S115 the user has not selected to automatically purchase a product based on the search results, in step S116 the search result items are output for display at the client device 100A or 100B. The system then awaits receipt of a user selection of an item in step S117. When a user section of an item is received, the process proceeds to step S118 for the purchase of the item. If there is no selection of an item by the user, the process terminates in step S119.

Returning to step S109 in FIG. 4A, if a user selects to perform a pre-search, in step S120 the search query is sent to the domain to perform the search and in step S121 the search results are received and output for display to the user on the client device 100A or 100B. The system then waits to determine whether the user selects an item in the search results in step S122. If not, the system then determines whether the user selects to accept the search results in step S123. If the user does not accept the search result, the process returns to step S107 for the user to re-input a search query.

If in steps S120 and S121 the pre-search results show that the product(s) are not available currently, the user can have the option to place a pre-order with automated payment when the item is available.

If in step S123 the user selects to accept the search results the process proceeds to step S110 to store the search query and domain. The process can then proceed as described above except that in step S111, the action date can be set based on information on the search result items. The search result items may be for example products for purchase having availability and delivery information. This information can be used to determine when the search should be re-run in time for an order to be placed for delivery before or on the event date. In this example, the re-running of the search on the action date enables the search to capture up to date information on products, while allowing the user not to have to make an early purchase at a time they remember or are available to make the purchase just so that they do not miss the event e.g. forget to buy a birthday gift for David.

On the action date, the user can be notified that the search has been triggered so that even if they have selected the auto purchase option and forgotten about it. They will not be surprised when certain processing activity takes place.

If in step S122 the user selects an item or items in the pre-search results, in step S124 in FIG. 4B data is stored on the selected items in the deferred search database 150. In step S125 the action date can then be determined for the triggering of the search based on the data from the pre-search. The search result items may be for example products for purchase having availability and delivery information. This information can be used to determine when the search should be re-run in time for an order to be placed for delivery before or on the event date.

The process then waits for the action date to arrive in step S126. On the action date in step S127 the search query is sent to the search domain to search for the selected items and in step S128 the system determines whether the search results confirm that the selected items are available from the merchant. If the product(s) are not available, the process terminates in step S119.

If the product(s) are available, in step S129 the system then determines whether the user has selected for there to be an automatic purchase based on the search results. If so, in step S130 a process is carried out to place an order or purchase the selected product(s).

If in step S129 the user has not selected to automatically purchase a product based on the search results, in step S131 the search result items are output for display at the client device 100A or 100B. The system then awaits receipt of a user selection of an item in step S132. When a user section of an item is received, the process proceeds to step S130 for the purchase of the item. If there is no selection of an item by the user, the process terminates in step S119.

In the example discussed with reference to FIGS. 4A to 4C, reference is made to the query being generated as a single query. The input by the user can result in a query being generated that is a multiple query: a smart search or compound search. The query could be generated to be spread across multiple categories. The query can also be generated to return results for multiple different users/people, e.g. Christmas gifts for Grandma and David. The search query could also be generated to search for multiple types of products or services. In this way a compound search is performed providing compound search results for an event.

FIGS. 5A to 5C illustrate a user interface 200 at a client device 100A or 100B. In FIG. 5A, the user interface display the current date and time 203 in the bottom right hand corner of the display. A search query input region 202 is provide to enable a user to input a search string to form the query. Selectable buttons 204, 206 and 205 are displayed to allow a user to select to allow the system to auto suggest a search query, to perform a pre-search and to carry out an automatic purchase. A calendar 201 is displayed to allow a user to select an event or to create an event in the calendar. In the calendar displayed there is a selectable event labelled “Tom's birthday” on the event date of 15 Jan. 2018.

FIG. 5B illustrates the user interface 200 after a user has entered a user query and requested a pre-search i.e. at step S122 in the flow diagram of FIG. 4A. It can be seen at 203 that the time has incremented and that search results 207 are displayed as suggested gifts for Tom's birthday. The user has the option to select an item (step S122) or to refine the search using the entry 208 (the transition from step S123 to step S107) in FIG. 4A). In addition, the user may have the option to simply accept the search query without making any selection of an item so that the query is re-run (the transition from step S123 to step S110 in FIG. 4A).

FIG. 5C illustrates the user interface 200 on the action date of 10 Jan. 2018 as illustrated by the date and time 203. The user has not selected to auto purchase the item and hence the user interface displays the suggested item for Tom's birthday gift as an image of the item 211, with a prechosen size or large and a prechosen colour of red based on stored preferences for Tom in Tom's associated user data. The user interface 200 also displays user selectable options 209 and 210 to change the suggested size and colour if the user feels that a different size and colour is more appropriate. The user interface 200 also displays a checkout option 212 to allow a user to select to purchase the item.

In embodiments, the users can allow other users to access certain of their personal data in a peer-to-peer data sharing manner. In this way preferences of the user and an associated user for the user can be shared with another user. Also, users can use the system to communicate with one another by sending messages, such as instant messages.

The user may allow a trusted third party to access certain of their personal data by using login data or a API. The trusted third party could be a financial institution or a medically associated entity such as a pharmacy. A pharmacy may be allowed to access the users personal data to determine when it may be appropriate to reorder medication for example.

The joint account may be used by members of a group under the control of a user as an administrator to allow the group such as a family to access and contribute towards the purchase of items such as gifts for events.

In embodiments, although the interface to the user has been described as web pages for a networked arrangement, any suitable interface technology could be employed. In one embodiment, the interface may be provided by an application running on a user's device. Embodiments also include software running on a standalone system, such as a personal computer, in which case the interface could be part of a single application that also performs the searches of data on the computer or a separate interface module to the search module that performs the search. The search module can transmit the data internally within the computer to a database or data store to perform the search to return the search results. In the context of this patent, the term “transmit” encompasses transmitting internally within a computer between modules as well as transmitting over a communications network, such as a local area network or the internet.

Throughout this patent the term “product” covers any form of tangible and intangible product including a service.

In the embodiments described above, the user interface provided (e.g. the web browser or APP) can enable users to communicate in any manner by sending messages and the like or even by voice or video communication. Also, the system can communicate with users by sending messages to messaging accounts such as WhatsApp® or a social media account such as Facebook®, that are linked by storing linking information in the user's data.

In embodiments data can be shared between users. For example, Steve may want to find a gift for David's birthday. Steve knows that Jane has data on David's preferences. Therefore, if Steve has been granted permission by Jane to access Jane's data held for her associated user David (Jane's user data indicates Steve is permitted to access the associated user preference data), then Steve can access the data for use in generating a query to find a suggested gift for David on his birthday. Steve may be allowed to share the data by simply accessing it or by copying the data into his user data for his associated user, David.

In one embodiment where the event is an appointment desired for a service such as a doctor, dentist, car repair etc., on the action date the relevant appointment system for the service is queried and suggested appointments returned as the search results. A user can view the search results and then select one as the desired one either manually or automatically where the auto suggest option is selected by the user when setting up the deferred search. Thus the result is the booking of the selected appointment.

The ‘user’ of the system can be an individual or a unit or entity such as a business, charity, social group etc. The event can thus be associated with the user, unit, entity or business. The diary or calendar used for event selection or creation can thus be a diary associated with the unit, entity or business. For example, the event could be a stock up day. The pre-search and deferred search would be able to check and search with for example other businesses/merchants/suppliers-systems to check and request that certain goods are available. With the automation of the process, an order can be made for delivery depending on whether the responses to the query satisfy the query. The deferred search and ordering process can be stored to be repeated for repeat events e.g. repeated monthly order date.

In one embodiment, the system can perform automated ordering and purchasing and can display to the user costs and totals. The user can set a budget that can be used to control purchases to ensure that the user's costs stay within the assigned budget.

As part of the search, the system can search for deals e.g. special offers, coupons, promocodes, etc. which can be acknowledge considered, applied and used if suitable or saved e.g. on user account for later use. If saved for later use, the voucher or coupon can be checked e.g. using a pre-search to make sure it is still in date/valid.

The system can save and apply virtual monies including any credits, vouchers, etc. For example, a virtual birthday voucher on the account for David can be redeemed so that the balance is paid e.g. by payment card, or where a credit is left over it can be saved on the user's account to use towards the next item purchased.

Where the user is a business, searching and ordering can be done on a much larger scale and searches for multiple products can be performed to automate a bulk ordering system.

### Basic Computing Device

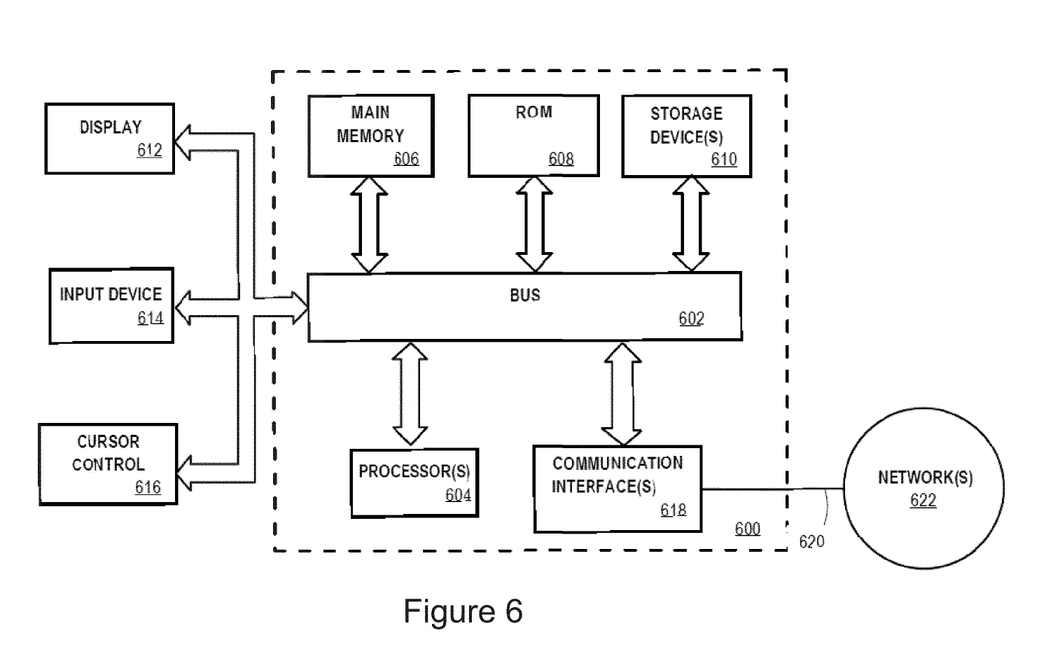

FIG. 6 is a block diagram that illustrates a basic computing device 600 in which the example embodiment(s) of the present invention may be embodied. Computing device 600 and its components, including their connections, relationships, and functions, is meant to be exemplary only, and not meant to limit implementations of the example embodiment(s). Other computing devices suitable for implementing the example embodiment(s) may have different components, including components with different connections, relationships, and functions.

The computing device 600 can comprise any of the servers or the user device as illustrated in FIG. 1 for example.

Computing device 600 may include a bus 602 or other communication mechanism for addressing main memory 606 and for transferring data between and among the various components of device 600.

Computing device 600 may also include one or more hardware processors 604 coupled with bus 602 for processing information. A hardware processor 604 may be a general purpose microprocessor, a system on a chip (SoC), or other processor.

Main memory 606, such as a random access memory (RAM) or other dynamic storage device, also may be coupled to bus 602 for storing information and software instructions to be executed by processor(s) 604. Main memory 606 also may be used for storing temporary variables or other intermediate information during execution of software instructions to be executed by processor(s) 604.

Software instructions, when stored in storage media accessible to processor(s) 604, render computing device 600 into a special-purpose computing device that is customized to perform the operations specified in the software instructions. The terms “software”, “software instructions”, “computer program”, “computer-executable instructions”, and “processor-executable instructions” are to be broadly construed to cover any machine-readable information, whether or not human-readable, for instructing a computing device to perform specific operations, and including, but not limited to, application software, desktop applications, scripts, binaries, operating systems, device drivers, boot loaders, shells, utilities, system software, JAVASCRIPT, web pages, web applications, plugins, embedded software, microcode, compilers, debuggers, interpreters, virtual machines, linkers, and text editors.

Computing device 600 also may include read only memory (ROM) 608 or other static storage device coupled to bus 602 for storing static information and software instructions for processor(s) 604.

One or more mass storage devices 610 may be coupled to bus 602 for persistently storing information and software instructions on fixed or removable media, such as magnetic, optical, solid-state, magnetic-optical, flash memory, or any other available mass storage technology. The mass storage may be shared on a network, or it may be dedicated mass storage. Typically, at least one of the mass storage devices 610 (e.g., the main hard disk for the device) stores a body of program and data for directing operation of the computing device, including an operating system, user application programs, driver and other support files, as well as other data files of all sorts.

Computing device 600 may be coupled via bus 602 to display 612, such as a liquid crystal display (LCD) or other electronic visual display, for displaying information to a computer user. In some configurations, a touch sensitive surface incorporating touch detection technology (e.g., resistive, capacitive, etc.) may be overlaid on display 612 to form a touch sensitive display for communicating touch gesture (e.g., finger or stylus) input to processor(s) 604.

An input device 614, including alphanumeric and other keys, may be coupled to bus 602 for communicating information and command selections to processor 604. In addition to or instead of alphanumeric and other keys, input device 614 may include one or more physical buttons or switches such as, for example, a power (on/off) button, a “home” button, volume control buttons, or the like.

Another type of user input device may be a cursor control 616, such as a mouse, a trackball, a cursor, a touch screen, or direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane. Other input device embodiments include an audio or speech recognition input module to recognize audio input such as speech, a visual input device capable of recognizing gestures by a user, and a keyboard.

While in some configurations, such as the configuration depicted in FIG. 6, one or more of display 612, input device 614, and cursor control 616 are external components (i.e., peripheral devices) of computing device 600, some or all of display 612, input device 614, and cursor control 616 are integrated as part of the form factor of computing device 600 in other configurations.

In addition to or in place of the display 612 any other form of user output device can be used such as an audio output device or a tactile (vibrational) output device.

Functions of the disclosed systems, methods, and modules may be performed by computing device 600 in response to processor(s) 604 executing one or more programs of software instructions contained in main memory 606. Such software instructions may be read into main memory 606 from another storage medium, such as storage device(s) 610 or a transmission medium. Execution of the software instructions contained in main memory 606 cause processor(s) 604 to perform the functions of the example embodiment(s).

While functions and operations of the example embodiment(s) may be implemented entirely with software instructions, hard-wired or programmable circuitry of computing device 600 (e.g., an ASIC, a FPGA, or the like) may be used in other embodiments in place of or in combination with software instructions to perform the functions, according to the requirements of the particular implementation at hand.

The term “storage media” as used herein refers to any non-transitory media that store data and/or software instructions that cause a computing device to operate in a specific fashion. Such storage media may comprise non-volatile media and/or volatile media. Non-volatile media includes, for example, non-volatile random access memory (NVRAM), flash memory, optical disks, magnetic disks, or solid-state drives, such as storage device 610. Volatile media includes dynamic memory, such as main memory 606. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, flash memory, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications. A machine readable medium or carrier medium carrying instructions in the form of code can comprise a non-transient storage medium and a transmission medium.

Various forms of media may be involved in carrying one or more sequences of one or more software instructions to processor(s) 604 for execution. For example, the software instructions may initially be carried on a magnetic disk or solid-state drive of a remote computer. The remote computer can load the software instructions into its dynamic memory and send the software instructions over a telephone line using a modem. A modem local to computing device 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor(s) 604 retrieves and executes the software instructions. The software instructions received by main memory 606 may optionally be stored on storage device(s) 610 either before or after execution by processor(s) 604.

Computing device 600 also may include one or more communication interface(s) 618 coupled to bus 602. A communication interface 618 provides a two-way data communication coupling to a wired or wireless network link 620 that is connected to a local network 622 (e.g., Ethernet network, Wireless Local Area Network, cellular phone network, Bluetooth wireless network, or the like). Communication interface 618 sends and receives electrical, electromagnetic, or optical signals that carry digital data streams representing various types of information. For example, communication interface 618 may be a wired network interface card, a wireless network interface card with an integrated radio antenna, or a modem (e.g., ISDN, DSL, or cable modem).

Network link(s) 620 typically provide data communication through one or more networks to other data devices. For example, a network link 620 may provide a connection through a local network 622 to a host computer or to data equipment operated by an Internet Service Provider (ISP). ISP in turn provides data communication services through the world wide packet data communication network now commonly referred to as the “Internet”. Local network(s) 622 and Internet use electrical, electromagnetic or optical signals that carry digital data streams. The signals through the various networks and the signals on network link(s) 620 and through communication interface(s) 618, which carry the digital data to and from computing device 600, are example forms of transmission media.

Computing device 600 can send messages and receive data, including program code, through the network(s), network link(s) 620 and communication interface(s) 618. In the Internet example, a server might transmit a requested code for an application program through Internet, ISP, local network(s) 622 and communication interface(s) 618.

The received code may be executed by processor 604 as it is received, and/or stored in storage device 610, or other non-volatile storage for later execution.

One aspect provides a carrier medium, such as a non-transient storage medium storing code for execution by a processor of a machine to carry out the method, or a transient medium carrying processor executable code for execution by a processor of a machine to carry out the method. Embodiments can be implemented in programmable digital logic that implements computer code. The code can be supplied to the programmable logic, such as a processor or microprocessor, on a carrier medium. One such embodiment of a carrier medium is a transient medium i.e. a signal such as an electrical, electromagnetic, acoustic, magnetic, or optical signal. Another form of carrier medium is a non-transitory storage medium that stores the code, such as a solid-state memory, magnetic media (hard disk drive), or optical media (Compact disc (CD) or digital versatile disc (DVD)).

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

1. A method of deferred searching, the method comprising:
receiving an event input identifying event data for an event on an event date in the future from a user at a user interface;
receiving a query input from the user at the user interface;
processing the query input using the event data to generate a query using a processor;
transmitting the query in dependence upon the event data; and
receiving the search results responsive to the transmitted query.

2. A method of deferred searching according to claim 1, wherein the query is transmitted over a network, and the search results responsive to the transmitted query are received over the network.

3. A method of deferred searching according to claim 1, wherein the event data has data identifying one or more users associated with the user, or the method includes receiving data identifying one or more users associated with the user, and the processing of the query input includes using the data identifying one or more associated users to generate the query.

4. A method of deferred searching according to claim 3, wherein the processing of the query input using the data identifying one or more associated users to generate the query includes using the data identifying one or more associated users to determine data related to the one or more associated user, and using the data related to the one or more associated users to generate the query.

5. A method of deferred searching according to claim 1, including performing at least one electronic transaction using the search results.

6. A method of deferred searching according to claim 5, including receiving a selection for automatic purchase from the user in association with the query input, and the at least one electronic transaction is performed automatically using the search results.

7. A method of deferred searching according to claim 5, including outputting the search results for display and receiving a user selection of one or more search results, wherein the at least one electronic transaction is performed using the user selected one or more search results.

8. A method of deferred searching according to claim 1, wherein the query input comprises a selection from the user for automatic search result determination, and the query is generated using the event data.

9. A method of deferred searching according to claim 1, wherein the query input comprises a user input text string as a search query, and the user input text string is processed using the event data to generate a query.

10. A method of deferred searching according to claim 1, wherein an action date is determined as part of the event data, the action date is prior to the event date, and the query is transmitted on the action date.

11. A method of deferred searching according to claim 10, wherein the action date is determined based on a received user input, or based on information related to the search results.

12. A method of deferred searching according to claim 11, including transmitting the query and receiving initial search results responsive to the query before the transmitting of the query in dependence upon the event data, and determining the action date using the initial search results.

13. A method of deferred searching according to claim 10, wherein a user notification is generated and output to the user on the action date.

14. A method of deferred searching according to claim 1, wherein the search results are output for display to the user.

15. A method of deferred searching according to claim 1, wherein the event is an event in a diary or calendar of the user.

16. A method of deferred searching according to claim 1, wherein the query comprises a composite query for multiple products, and the results comprise search results for the multiple products.

17. A system for deferred searching comprising:
at least one processor; and
a memory storing instructions, which instructions being executable by the at least one processor to:
receive an event input identifying event data for an event on an event date in the future from a user at a user interface;
receive a query input from the user at the user interface;
process the query input using the event data to generate a query;
transmit the query in dependence upon the event data; and
receive the search results responsive to the transmitted query.

18. A system for deferred searching according to claim 17, wherein the query is transmitted over a network, and the search results responsive to the transmitted query are received over the network.

19. A system for deferred searching according to claim 17, wherein the event data has data identifying one or more users associated with the user, or the system includes instructions executable by the at least one processor to receive data identifying one or more users associated with the user, and the processing of the query input includes using the data identifying one or more associated users to generate the query.

20. A system for deferred searching according to claim 19, wherein the instructions executable by the at least one processor to process the query input using the data identifying one or more associated users to generate the query includes instructions executable by the at least one processor to use the data identifying one or more associated users to determine data related to the one or more associated user, and to use the data related to the one or more associated users to generate the query.

21. A system for deferred searching according to claim 17, including instructions executable by the at least one processor to perform at least one electronic transaction using the search results.

22. A system for deferred searching according to claim 21, including instructions executable by the at least one processor to receive a selection for automatic purchase from the user in association with the query input, wherein the instructions executable by the at least one processor to perform the at least one electronic transaction comprises instructions executable by the at least one processor to automatically perform the electronic transaction using the search results.

23. A system for deferred searching according to claim 21, including instructions executable by the at least one processor to output the search results for display and to receive a user input of one or more search results, wherein the instructions executable by the at least one processor to perform the at least one electronic transaction comprises instructions executable by the at least one processor to perform the at least one electronic transaction using the user selected one or more search results.

24. A system for deferred searching according to claim 17, wherein the query input comprises a selection from the user for automatic search result determination, and the instructions executable by the at least one processor to generate the query comprises instructions executable by the at least one processor to generate the query using the event data.

25. A system for deferred searching according to claim 17, wherein the query input comprises a user input text string as a search query, and the instructions executable by the at least one processor to process the user input text string comprises instructions executable by the at least one processor to process the user input text string using the event data to generate a query.

26. A system for deferred searching according to claim 17, including instructions executable by the at least one processor to determine an action date as part of the event data, wherein the action date is prior to the event date, and instructions executable by the at least one processor to transmit the query comprises instructions executable by the at least one processor to transmit the query on the action date.

27. A system for deferred searching according to claim 26, wherein the instructions executable by the at least one processor to determine the action date comprises instructions executable by the at least one processor to determine the action date based on a received user input, or based on information related to the search results.

28. A system for deferred searching according to claim 27, including instructions executable by the at least one processor to transmit the query and receive initial search results responsive to the query before the transmitting of the query in dependence upon the event data, and instructions executable by the at least one processor to determine the action date using the initial search results.

29. A system for deferred searching according to claim 26, including instructions executable by the at least one processor to generate a user notification and output the user notification to the user on the action date.

30. A system for deferred searching according to claim 17, including instructions executable by the at least one processor to output the search results for display to the user.

31. A system for deferred searching according to claim 17, wherein the event is an event in a diary or calendar of the user.

32. A system for deferred searching according to claim 17, wherein the query comprises a composite query for multiple products, and the results comprise search results for the multiple products.

33. A non-transient storage medium storing processor executable code for execution by a processor to:
receive an event input identifying event data for an event on an event date in the future from a user at a user interface;
receive a query input from the user at the user interface;
process the query input using the event data to generate a query;
transmit the query in dependence upon the event data; and
receive the search results responsive to the transmitted query.
